(19) United States
(12) Patent Application Publication
(10) Pub. No.: US 2025/0383270 A1
(43) Pub. Date: Dec. 18, 2025

(54) PAN STATUS INDICATOR LIGHT FOR ANALYTICAL INSTRUMENT SAMPLE TRAY

(71) Applicant: TA Instruments-Waters LLC, New Castle, DE (US)

(72) Inventors: Jeffrey Marvin, New Castle, DE (US); Reginald Lee, West Chester, PA (US)

(21) Appl. No.: 19/235,842

(22) Filed: Jun. 12, 2025

Related U.S. Application Data
(60) Provisional application No. 63/659,165, filed on Jun. 12, 2024.

(51) Int. Cl. G01N 1/36; F21V 9/40; F21Y 115/10

(52) U.S. Cl. CPC G01N 1/36; F21V 9/40; F21Y 2115/10

(57) ABSTRACT

A tray status indicator system comprises a tray comprising a plurality of wells. Each well in the plurality of wells is configured to receive a sample or reference material. A light emitting diode (LED) arrangement is below the plurality of wells. Each LED in the LED arrangement is below a well of the plurality of wells. The system also comprises an instrument control system that generates and outputs control signals to the LED arrangement to illuminate the each LED in the LED arrangement at a predetermined color of a plurality of different colors that indicate a state of a sample or reference in the well.

### RELATED APPLICATIONS

This application claims priority to U.S. provisional patent application No. 63/659,165 filed Jun. 12, 2024 and titled “Pan Status Indicator Light for Analytical Instrument Sample Tray,” the contents of which are incorporated by reference in their entirety.

### FIELD OF THE PRESENT DISCLOSURE

The disclosed technology generally relates to laboratory instrumentation. More particularly, the disclosed technology relates to a sample pan status indicator system for multi-sample trays used with analytical instrument autosamplers of thermal analysis systems.

### BACKGROUND

Many thermal instruments utilize autosamplers and a robotic arm for automated sample handling. During operation, samples are stored in a tray having numbered tray positions so that a user can distinguish the samples in the tray. The autosampler picks up and places individual samples in these positions. Users input sample information into computer software, then physically place the sample in a tray position.

There are many complex variables related to a sample, such as run status, pan type, username, test type, pass/fail criteria, error status, etc. Currently, all of this sample-related information is accessible only through a user interface of control software on a computer display. This is inconvenient for users, as it adds an extra step in their workflow to physically move to the computer to check these variables. There are many stages in sample preparation, running experiments, and viewing results where users value ease of use and efficiency. Users must rely on a user interface produced by the instrument control software to check a sample status. There is no physical feedback is available at the tray itself. Therefore, users must memorize tray positions or repeatedly refer back to the user interface, which is inefficient and prone to user error and requires time-consuming sample preparation and loading.

### SUMMARY

In accordance with aspects of the inventive concepts, provided in one aspect is a tray status indicator system, comprising a tray comprising: a plurality of wells, each well in the plurality of wells configured to receive a sample or reference material; and a light emitting diode (LED) arrangement below the plurality of wells, wherein each LED in the LED arrangement is below a well of the plurality of wells. The system also comprises an instrument control system that generates and outputs control signals to the LED arrangement to illuminate the each LED in the LED arrangement at a predetermined color of a plurality of different colors that indicate a state of a sample or reference in the well.

In another aspect, a tray for holding a plurality of samples comprises a plurality of wells, each well in the plurality of wells configured to receive a pan comprising a sample or reference material; and an LED arrangement below the plurality of wells, wherein each LED in the LED arrangement is below a well of the plurality of wells. A computer interface exchanges control signals with an instrument control system that generates and outputs control signals to the LED arrangement, which in response illuminates well of the plurality of wells by an LED in the LED arrangement below the well at a predetermined color of a plurality of different colors according to the control signals that indicate a state of a sample in the well.

In another aspect, an automated sample preparation system for thermal analysis comprises an autosampler including an automated gripping system configured to pick up a pan located in a well of a sample tray; the sample tray having an LED below the well; and an instrument control system that generates and outputs control signals to the LED to control the autosampler and to illuminate the LED at a predetermined color of a plurality of different colors that indicate at least one of a sample, system, or instrument status at the well.

### BRIEF DESCRIPTION OF THE DRAWINGS

Advantages of this present disclosure may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles with reference to the concepts described in the present disclosure.

FIG. 1 is a block diagram of a differential scanning calorimetry (DSC) instrument in which embodiments of the present inventive concept can be practiced.

FIG. 2A is a perspective view of a sample tray, in accordance with some embodiments.

FIG. 2B is a cross-sectional front view of the sample tray of FIG. 2A.

FIG. 3 is a cross-sectional front view of a sample tray having a cover, in accordance with other embodiments.

FIG. 4 is a diagram of a user interface display and corresponding descriptors for a sample tray, in accordance with some embodiments.

FIG. 5 is a diagram of a user interface for managing LED indicators of a sample tray, in accordance with some embodiments.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

In brief overview, embodiments of the present inventive concept include an autosampler tray integrated with individually addressable indicators such as RGB light emitting diode (LED) lights or the like at each sample position, or well, of the tray so that a plurality of samples in the tray can be in various states individually identified by red-green-blue (RGB) LED lights. In particular, these well-based lights can serve as indicators that display customizable colors corresponding to a status of a sample. The instrument control software can control the indicators, offering visual, intuitive feedback directly on the tray. In some embodiments, the instrument control software can display a replicate sample status, for example, an LED under a sample may illuminate red indicating a particular status of the sample while a user interface may display a red indicator corresponding to the same sample.

Conventional trays are generally formed of injection molded plastic and each sample position, or well, is numbered. However, a sample tray in accordance with the embodiments herein includes individually addressable RGB LED lights in each numbered tray position in addition to or instead of numbers. These lights individually illuminate each tray position with a customizable color. These colors are linked to a computer that stores and executes instrument status and control software so that it reflects the status of some variable about the sample that a user might care about. The software is customizable to set color options for a list of possible variables that are relevant to the instrument or a workflow. This may include default color templates chosen to reflect common user needs, or it can be completely customized by users to define the exact sample variable and color that they would like displayed. The autosampler tray material can be modified to accommodate these lights, for example with a shine through plastic material, or other way to clearly illuminate each position. This provides users with a quick and intuitive visual reference of their sample status, which increases efficiency and reduces errors. This feature can be deployed in a quality control lab, where tray position-based LEDs can reflect a test status of pass, e.g., green, or fail, e.g., red. In other embodiments, this feature can be used for sample preparation, for example, illuminating active positions of a tray to direct users where to place samples). Other uses may include, but not be limited to experiment status, experiment queue, calibration pans/samples, error states, reference vs. sample pans, reserved positions, user profiles, test type, pan type, or any other instrument parameter or workflow step. This can reduce reliance on the computer display while minimizing user error, mental load, and training time, and enhancing workflow efficiency and usability at the point of interaction. Since each tray position is illuminated with a color-coded LED that reflects the sample's status, users are not required to check the software interface to determine the status of a sample, e.g., which sample is next, which is reserved, or which has failed a quality control (QC) test. Instead of remembering which pan corresponds to which sample or status, users can simply follow the illuminated tray positions. For example, a pan that should not be discarded can be illuminated by a customizable LED that illuminates the pan with a red color, while a reference pan might be blue. In some environments, LEDs can guide users step-by-step through sample loading or weighing by lighting up the correct tray position in sequence. This reduces the need to switch back and forth between the tray and the software interface. In some embodiments, pan status indicator system comprising LEDs for each sample position in a tray can be integrated with an instrument control system, e.g., that controls an autosampler and/or other components of a thermal analysis system such as a DSC to reflect an experiment queue status, calibration state, or user profile directly on the tray. This minimizes the need to navigate through multiple software menus to retrieve this information. Thus, new users can follow intuitive color cues rather than learning complex software workflows, which can reduce user error.

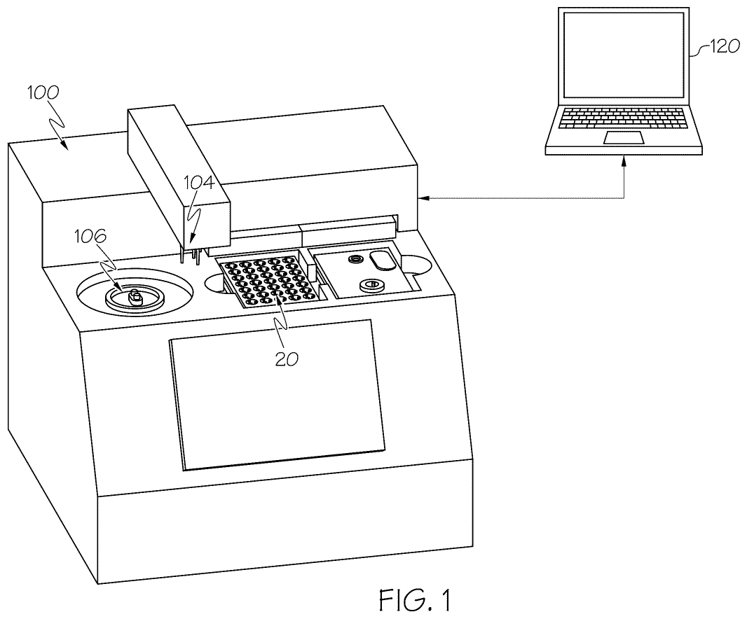

FIG. 1 is a block diagram of a differential scanning calorimetry (DSC) instrument 100 in which embodiments of the present inventive concept can be practiced. As shown, the DSC instrument 100 communicates with a computer 120 that stores and executes an instrument control system including a user interface for entering data into the computer 120 for processing by the DSC instrument 100. Although a DSC instrument 100 is shown and described, other thermal analysis systems that use autosampler trays may equally apply.

The DSC instrument 100 includes a DSC cell 106 where sample and reference materials are placed for testing. The DSC cell 106 may include a sample holder (not shown), e.g., a small pan or crucible where the sample material is placed and a reference holder (not shown), or an identical empty pan or inert material used for comparison. Although a description is made throughout of reference materials being in a pan, which in turn is provided to a tray, other embodiments may include a reference without a pan. Testing may include heat flow measurements performed on samples of interest at the sample holder of the DSC cell 106. In some embodiments, the DSC instrument 100 uses an autosampler 104 to automate sample loading from a tray 20.

In particular, the autosampler 104 is a robotic mechanism that automatically loads and unloads samples into the DSC cell 106. For example, the autosampler 104 includes robotic components such as a gripper, etc. to pick up a sample pan from a tray position of the tray 20 and transfers it into the DSC cell 106 for thermal testing. After testing, the autosampler 104 removes the sample plan after the test is complete and places it in a disposal or return slot. The autosampler 104 can be programmed with the tray layout, and when in communication with the user interface or other software of the computer 120 that initiates a run can move a pan of the tray 20 to the cell 106, wait for completion of testing of the sample 12 in the pan, retrieve the pan and moves to the next sample pan in the tray 20.

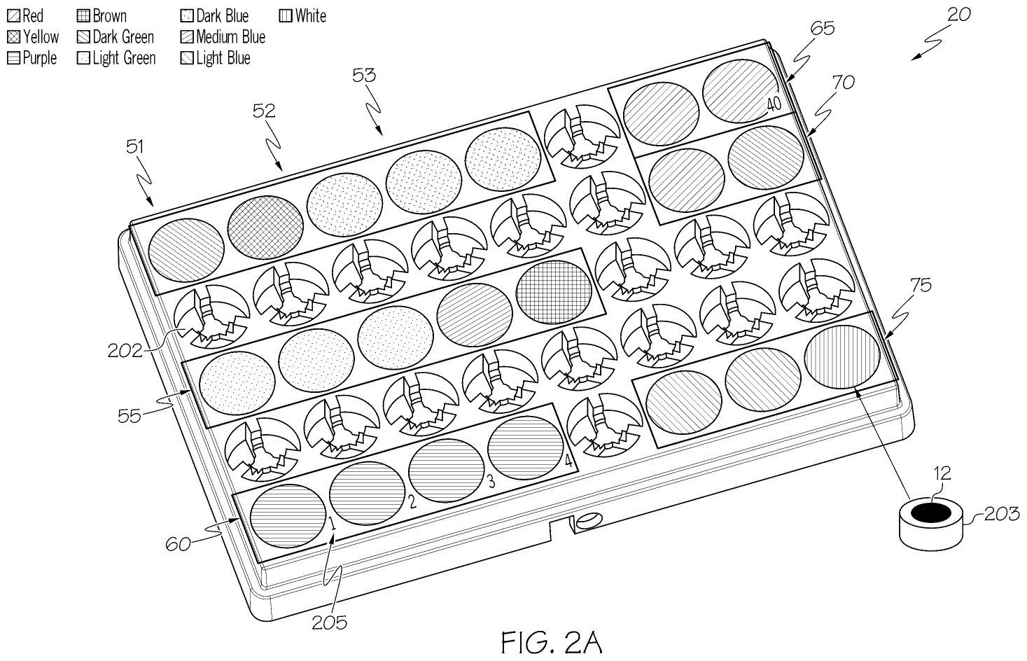

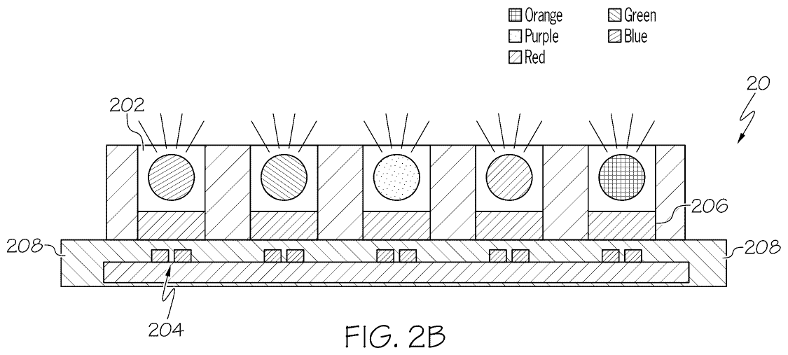

FIG. 2A is a perspective view of the sample tray 20 of FIG. 1. FIG. 2B is a cross-sectional front view of the sample tray 20 of FIGS. 1 and 2A.

The sample tray 20 includes an array of wells 202. Each well 202 may receive a pan 203 or other small container, e.g., formed of metal or other material, which holds a single sample 12 or reference material for testing. During operation, the autosampler 104 can remove a pan 203 from the tray 20 located at a staging area of the DSC instrument 100 and place it inside a test chamber such as the DSC cell 106. The autosampler 104 can be configured to know the location of a pan 203 of interest in the tray 20 based on a predefined geometry, e.g., the pan 203 is 10 mm from the edge of the tray to determine the tray position or known (x,y,z) coordinate, and position numbering. This information can be stored at the computer 120 and controlled by the instrument control system, which can include software executed by the computer 120 to map the x,y,z coordinate maps to a position number 205 at the tray 20. In some embodiments, each well 202 can have a corresponding numbered position 205 that is stamped, ingrained, or otherwise integrated with the body of the tray 204, which may be formed of injection-molded plastic or the like. For example, the instrument software executed by the computer 120 can assign a tray position number 205 to a sample within an experiment created in the instrument software. This assignment creates an association between the sample and experiment metadata, and the selected tray position. Metadata can include sample ID or name, pan type, profile, test type, QC status (pass/fail), calibration status, experiment queue position, and/or error flag with the selected position in the autosampler tray 20. Accordingly, the tray 20 may be aligned within the autosampler 104 so the robotic arm can locate the correct pan 203 in the tray, grab the pan 203 with a specialized tool or gripper, and move it from the tray 20 into the DSC cell 106.

In some embodiments, the tray 20 includes an LED array 204 comprising a plurality of LED indicators that illuminate in a predetermined manner to show pan status, active position, or user-defined codes. The LED array 204 may be constructed and arranged for positioning in a plate 208, for example, formed of aluminum, SST, or the like. In some embodiments, the LED indicators include individually addressable RGB LEDs for each tray position. Each tray position may include RGB LEDs 204 underneath or proximal to the wells 202 of the tray 20 or otherwise integrated into the tray 20, where the pans 202 are inserted into the wells 202, for example, manually by the user, which is why the LEDs 204 are important. For example, the LEDs 204 can illuminate individual positions to show active or reserved pans, indicate pass/fail status, guide the user during setup or retrieval, and so on. In some embodiments, the LEDs 204 are each capable of displaying 16 million different colors, each customizable based on user-defined or pre-set variables. Therefore, each tray position can be illuminated with any of the 16 million available colors. In some embodiments, the LEDs 204 may complement the tray numbers 205 for tray positioning and reference, where the LEDs 204 enhance usability by providing instant visual guidance. In some embodiments, the autosampler tray 20 is formed of injection molded plastic tray or the like. The tray 20 may include a transparent material 206 such as clear plastic or glass between the LED array 204 and wells 202 to allow electromagnetic radiation, e.g., light, from the LEDs 204 to be seen from a viewer looking at the wells 202, or a region around the wells 202 when a pan 203 is inserted into the well.

The instrument control system stored as software and executed by the computer 120 can manage color-coding of the LEDs 204 based on various sample-specific or system-level variables, such as the metadata examples above: QC pass/fail status, experiment stage, e.g., running, queued, completed, pan type, reserved tray positions, calibration status, error conditions, e.g., autosampler or chiller error), and/or user profiles and test types, but not limited thereto. Using this metadata, control signals can be provided to the LEDs which in response can provide visual feedback on various instrument and system states, including autosampler errors, e.g., mechanical failure, calibration issue, chiller or instrument malfunctions, e.g., temperature control failure, experiment Queue Status, e.g., queued samples vs. currently running, calibration success or failure, e.g., green for pass, red for fail, reference pan and reserved positions for marking non-disposable pans or special samples, and so on. In some embodiment, the instrument control system includes a mapping system to control the RGB LED at each tray position. In some embodiments, as described above, each tray position, or well, may be numbered. In one example, referring to FIG. 2A, if position 40 is marked as “QC Fail,” the LED at position 40 lights up red. In another example, if position 1 is reserved for a specific user, the predetermined color-coding scheme may be processed by the computer 120 to light up position 1 purple. Thus, the LEDs 204 in the tray 20 can indicate system status, not just sample-related information.

In some embodiments, the color-coding can be user defined. Here, the user interface may display or otherwise communication information for a user to define color codes or choose from pre-loaded templates for experimental setups, guided sample placement and preparation, error and alert signals, and the like. This may pertain to a workflow performed by a thermal analysis system such as a DSC, for example, sample weighing, sample loading guidance, experiment queue visualization, and so on. The following is an example of a tray 20 having a user-defined color-coding scheme.

Pan 51 positioned in a well 202 of the tray 20 may be identified as being weighted. An LED may be illuminated dark green at the well 202 to refer to the pan 51 as having been weighed. Pan 52, on the other hand, may be currently being weighed, and an LED 204 may be illuminated yellow to indicate this status. Pans 53 may be a queue to be weighed, and their respective wells may be illuminated blue to indicate this status.

Region 55 of the tray 20 may refer to pans that are in an experiment queue, and their respective wells are illuminated to indicate various statuses in the experiment queue, such as completed (e.g., light green), currently running (e.g., blue), and in run queue (e.g., brown). Region 60 of the tray 20 may include pans that are to be saved, i.e., not discarded. The tray wells at region 60 may be illuminated purple. Region 65 of the tray 20 may include pans that experienced an instrument error, such as the autosampler, chiller, or another component of the DSC instrument 100. The wells of region 65 may be illuminated red to indicate an instrument error. Region 70 of the tray 20 may include pans undergoing a quality control (QC) operation, where one well is illuminated red indicating a QC pass and the other well is illuminated green indicating a QC fail. Region 75 of the tray 20 may include reference pans and corresponding calibration standards, each having a different colored LED.

There may be cases where a position is illuminated without a sample presently in the well. For example, an error may occur when a pan is dropped somewhere. Here, the corresponding well that the dropped pan belongs is illuminated a predetermined color, e.g., red, by the LED below the well, notwithstanding that the pan is missing. In another example, a pan is inside the cell being tested, and the well is illuminated by its LED by a color that is interpreted by a viewer that “this is the position which is currently inside the test cell” notwithstanding that the well would be empty.

FIG. 2A illustrates the flexibility offered by the multi-colored tray 20, since user-defined colors can be selected from a list of specific variables and pre-loaded color schemes or templates can be processed to generate the specific LED activations. In some instances, a particular color may have multiple meanings established by a user. For example, a red indicator at region 65 may refer to an instrument error while a red indicator at region 70 may refer to a QC fail status. In other words, the same color may or may not be shown at the same time, for example the “red QC status” rule may only be active while the instrument is idle, while the “red instrument error” rule is only active while the instrument is currently running. Therefore, there may be an additional setting in the rule to determine when a particular rule is active or not.

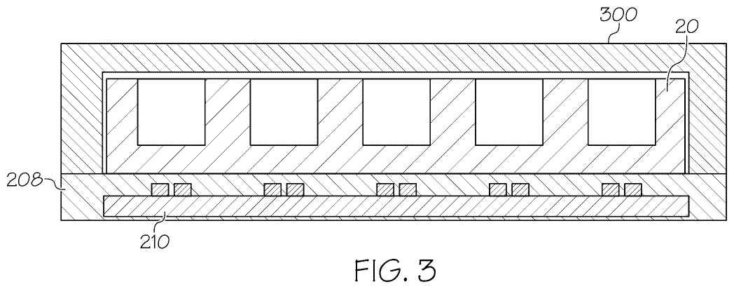

FIG. 3 is a cross-sectional front view of a sample tray 20 having a cover 300, in accordance with other embodiments. Details of the tray 20 are not repeated for brevity. In some embodiments, the cover 300 is a clear cover formed of polycarbonates (PC) or the like. The cover 300 can be constructed and arranged as a sliding cover, for example, for insertion or removal from the underlying plate 208. The LEDs may be arranged on a printed circuit board (PCB) or the like, which is positioned in the plate 208 to which the cover 300 is removably attached. In some embodiments, photodiodes may be also on the PCB for pan detection. In some embodiments, a cover motor driver (not shown) may be for operating the cover, i.e., opening and closing the cover 300 relative to the tray 20 to cover or expose the pans inside the wells of the tray 20. In some embodiments, the tray 20 may have one or more indicators, for example, a tray indicator, a photodiode pan indicator, and so on.

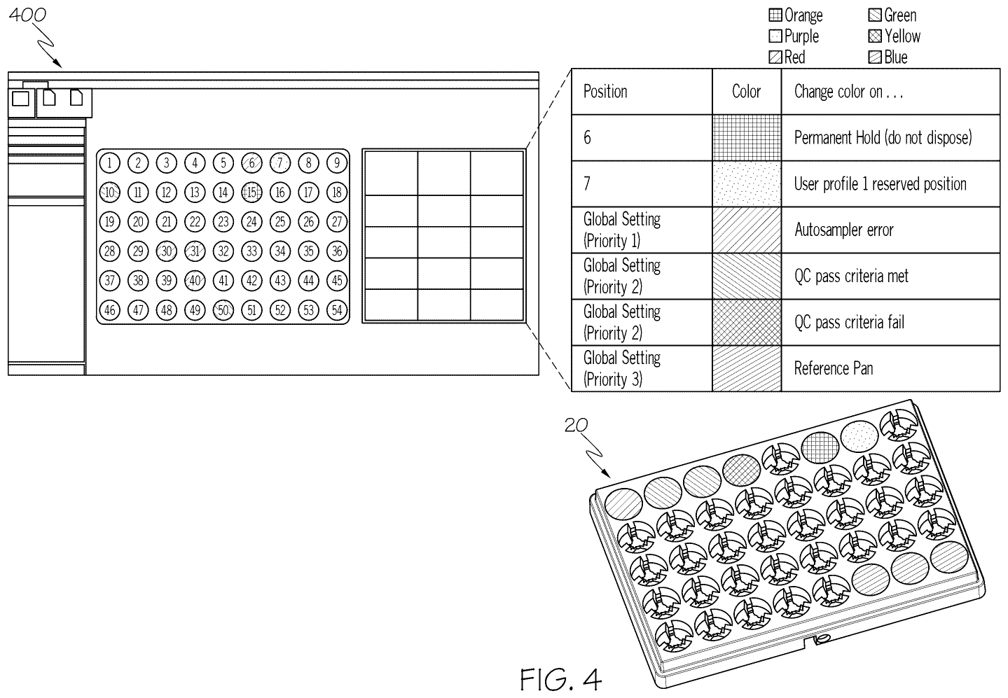

FIG. 4 is a diagram of a user interface display 400 and corresponding descriptors for a sample tray, in accordance with some embodiments. In describe the user interface 400, reference is made to the tray 20 in FIGS. 2A and 2B. The user interface display 400 can be generated by the instrument control system and displayed from the computer 120 shown in FIG. 1.

The user interface display 400 is configured to display visual information readily available at the DSC instrument 100. The visual information may include a color scheme that is the same as or similar to the LED arrangement of the tray 20. As shown in the blown-up portion of the display 400, a table maps relevant LED colors to a position of the tray 20 and a corresponding description. For example, as shown, an LED at position 6 is illuminated orange by the instrument control system indicating a permanent hold of the sample pan in the well at position 6.

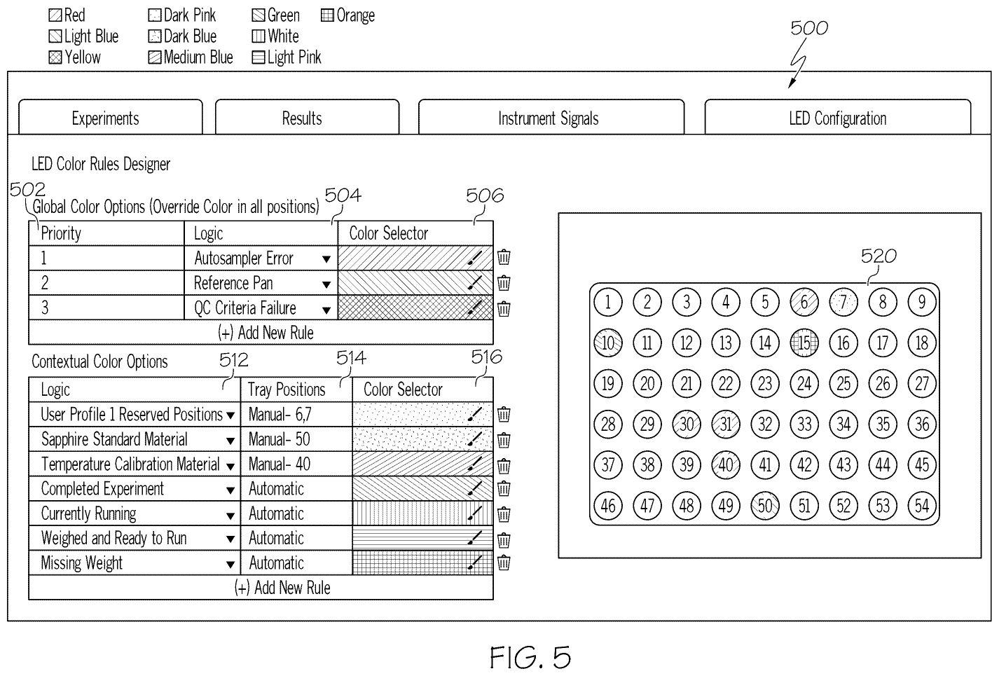

FIG. 5 is a diagram of a user interface 500 for managing LED indicators of a sample tray, in accordance with some embodiments. In describe the user interface 500, reference is made to the tray 20 in FIGS. 2A and 2B. The user interface display 500 can be generated by the instrument control system and displayed from the computer 120 shown in FIG. 1.

The user interface display 500 may permit a user to customize LEDs to illuminate colors according to a predetermined color template or the like, where each color is intended to notify the user of a status of a sample at a particular position of the sample tray 20. Also, the user can add or remove any number of rules, change their order or priority, and customize the color using a digital color selector. The software might also come with prepackaged rulesets that can be loaded to add a set of multiple rules to the table at once. Users can also save their custom rulesets in the software, so that they can reload that saved configuration at a later time, or switch between saved rulesets. The user interface display 500 may display a first control display that permits the user to select global color options that may override a color in all positions in the tray. Here, the first control display may display a priority 501 and logic 502 for each relevant color 503. For example, an autosampler error may have a high priority so that any tray position affected by the autosampler error is illuminated red. If a given tray position is illuminated a different color, then the LED at this position will receive a control signal to change the LED to be red.

The user interface display 500 may include a second control display that defines LED colors according to a set of rules that can be submitted to the second control display at a logic field 512. A tray position field 514 can display a status of the tray positions. For example, a tray position 40 may be manually assigned for the presence of a temperature calibration material, where this tray position 40 is illuminated by a blue LED according to field 516, while samples that have undergone a completed experiment may be identified by a green LED 516 automatically. In some embodiments, an image 520 of the tray may be displayed with color-based indicators for each position, which match the colors of the actual LEDs activated at the tray 20. For example, position 6 of the tray 20 is shown in the display image 520 as red so the LED at position 6 of the tray 20 is illuminated red.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A tray status indicator system, comprising:
a tray comprising:
a plurality of wells, each well in the plurality of wells configured to receive a sample or reference material; and
a light emitting diode (LED) arrangement below the plurality of wells, wherein each LED in the LED arrangement is below a well of the plurality of wells; and
an instrument control system that generates and outputs control signals to the LED arrangement to illuminate the each LED in the LED arrangement at a predetermined color of a plurality of different colors that indicate a state of a sample or reference in the well.

2. The tray status indicator system of claim 1, wherein the tray is an autosampler tray.

3. The tray status indicator system of claim 1, wherein the tray further comprises a transparent material between the LED arrangement and the each well to allow light in the plurality of different colors to be viewed by a user viewing the tray.

4. The tray status indicator system of claim 3, wherein the different colors are viewed from at least one above the tray or a region about the wells.

5. The tray status indicator system of claim 1, wherein the each LED is configured to receive the control signals to emit colors according to a customizable pre-loaded color scheme or template.

6. The tray status indicator system of claim 1, wherein for each tray position, a well of the plurality of wells is in communication with an individually addressable red-green-blue (RGB) LED.

7. The tray status indicator system of claim 1, wherein the LED array includes a printed circuit board that is positioned below or integrated into the tray.

8. The tray status indicator system of claim 1, wherein the LED array is constructed and arranged to display up to 16 million different colors, each color customizable based on user-defined or pre-set variables.

9. The tray status indicator system of claim 8, wherein the instrument control system manages a color-coding scheme of the LEDs based on the user-defined or pre-set variables, including at least one of a quality control (QC) status, an experiment stage, a pan type, a reserved tray position, a calibration status, an error condition, a user profile, a workflow status, and a test type.

10. The tray status indicator system of claim 1, further comprising a cover for removably positioning over the tray.

11. The tray status indicator system of claim 1, wherein the tray includes a numbering arrangement so that each well has a tray position number, and wherein the instrument control system includes a mapping system that associates metadata with the tray position numbers to control the color type emitted by the LED array.

12. A tray for holding a plurality of samples, comprising:
a plurality of wells, each well in the plurality of wells configured to receive a pan comprising a sample or reference material; and
an LED arrangement below the plurality of wells, wherein each LED in the LED arrangement is below a well of the plurality of wells;
a computer interface for exchanging control signals with an instrument control system that generates and outputs control signals to the LED arrangement, which in response illuminates well of the plurality of wells by an LED in the LED arrangement below the well at a predetermined color of a plurality of different colors according to the control signals that indicate a state of a sample in the well.

13. The tray of claim 12, wherein a well of the plurality of wells is illuminated in the absence of a pan.

14. The tray of claim 12, wherein the tray is an autosampler tray.

15. The tray of claim 12, wherein the tray further comprises a transparent material between the LED arrangement and the each well to allow light in the plurality of different colors to be viewed by a user viewing the tray.

16. The tray of claim 15, wherein the different colors are viewed from at least one above the tray or a region about the wells.

17. The tray of claim 12, wherein the each LED is configured to receive the control signals to emit colors according to a customizable pre-loaded color scheme or template.

18. The tray of claim 12, further comprising a cover for removably positioning over the tray.

19. The tray of claim 12, wherein the tray includes a numbering arrangement so that each well has a tray position number, and wherein the instrument control system includes a mapping system that associates metadata with the tray position numbers to control the color type emitted by the LED array.

20. An automated sample preparation system for thermal analysis comprising:
an autosampler including an automated gripping system configured to pick up a pan located in a well of a sample tray;
the sample tray having an LED below the well; and
an instrument control system that generates and outputs control signals to the LED to control the autosampler and to illuminate the LED at a predetermined color of a plurality of different colors that indicate at least one of a sample, system, or instrument status at the well.
